(19) United States
(12) Patent Application Publication
(10) Pub. No.: US 2005/0103053 A1
(43) Pub. Date: May 19, 2005

(54) Method for producing decorative ornaments

(76) Inventors: Mark E. Segill, Framingham, MA (US); Michael J. D'Angelo, Seekonk, MA (US); David Gordon Pelletier, Taunton, MA (US); Guran Arzu, Istanbul (TR)

Correspondence Address: FOLEY HOAG, LLP;PATENT GROUP, WORLD TRADE CENTER WEST, 155 SEAPORT BLVD, BOSTON, MA, 02110, US

(21) Appl. No.: 10/876,168

(22) Filed: Jun. 24, 2004

Related U.S. Application Data
(60) Provisional application No. 60/500,999, filed on Sep. 8, 2003.

(51) Int. Cl. C03B 31/00; C03B 27/02

(52) U.S. Cl. 65/60.3; 65/DIG. 3; 65/63; 65/69; 65/116; 65/111

(57) ABSTRACT

A decorative glass ornament may be formed from glass material and then caused to crack to produce an effect similar to that exhibited by naturally-occurring quartz: the glass is cracked or veined in random patterns. Glass material is heated and molded into a desired shape, and then, prior to substantial cooling, is dipped in a liquid medium having a lower temperature, causing cracks to form. Alternatively, a pre-shaped glass crystal may be caused to crack to produce a decorative ornament displaying similar effects. Epoxy paint may be applied to the ornaments after they have cracked, to produce additional visual effects.

### REFERENCE TO RELATED APPLICATIONS

This application claims the priority of U.S. Provisional Patent Applications No. 60/483361, filed on Jun. 27, 2003, and No. 60/500999, filed on Sep. 8, 2003, incorporated herein by reference.

### BACKGROUND

Chandelier ornaments made from naturally occurring cracked quartz are very attractive in appearance, but relatively expensive. It is desirable to produce a decorative glass ornament that has the “cracking” or “veining” of natural crystal, but with less expense involved as compared to locating and shaping naturally-occurring cracked quartz.

### SUMMARY

A glass ornament may be formed from glass material and then caused to crack to produce a visual effect similar to that exhibited by naturally-occurring quartz: the glass is cracked or veined in random patterns. Alternatively, a pre-shaped glass crystal may be caused to crack to produce similar visual effects.

### BRIEF DESCRIPTION OF THE DRAWINGS

FIG. 1-3 are photographs of cracked glass ornament produced from glass rods, in accordance with the invention, showing different visual effects that may result.

### DETAILED DESCRIPTION OF EXEMPLARY EMBODIMENTS

In a first aspect of applicants' method, raw glass material, such as glass rods comprising optically clear glass and/or silica glass, are heated to their melting temperatures. Acceptable glass rods may be obtained from Ar. Ran, Muhittin Ustundag cad. No55, Kosuyolu, 81020 Kadikoly, Istanbul, Turkey. The molten glass is poured into molds that have been pre-heated to temperatures similar to the melting temperatures of the raw glass materials. The molten glass is thus pressed or formed into any desirable shape. Image-altering agents, such as chemical color agents and chemical opacity agents, may be added to the molten glass mixture before pouring the mixture into the molds.

The molded glass shapes are removed from the molds prior to significant cooling and are then dipped into a liquid medium having a temperature substantially below the melting temperature of the raw glass material. For example, for raw glass material having a 900° C. melting temperature, the liquid medium may comprise 30° C. water. Differences between the temperatures of the molded glass shapes and the liquid medium cause the glass ornament shapes to crack. The ornaments may then be placed in sand that has been heated to a temperature greater than the temperature of the liquid medium, for purposes of stabilization of the glass ornament as it cools further.

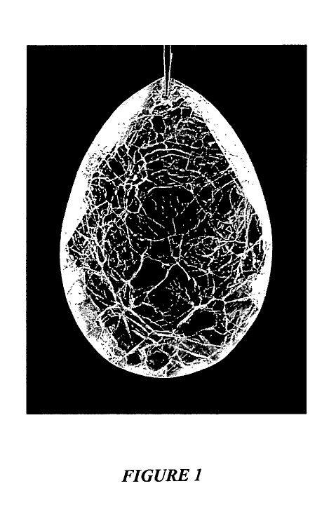

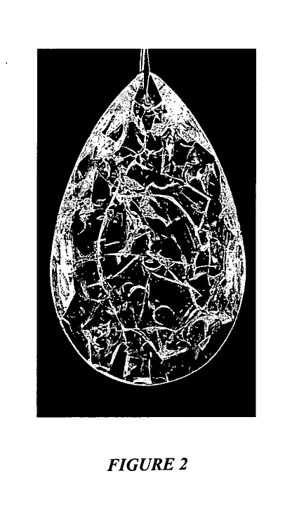

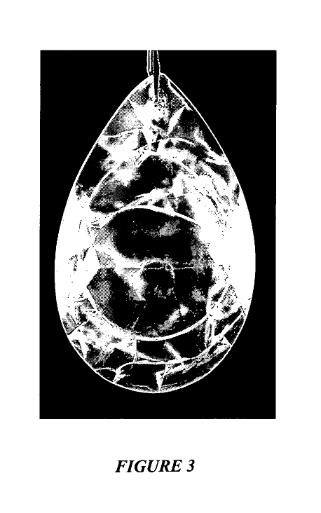

FIGS. 1-3 depict random variations in the cracking of the glass that may occur as a result of this process.

After the cracked glass has dried and cooled, the cracked shapes may then be cut or trimmed as desired. Epoxy paint of any desired color may be selectively applied to the glass—for example, along the edge of one side—to provide additional visual effects. The ornament may be baked for approximately 30 minutes at about 300° degrees Fahrenheit to set the epoxy. Suitable epoxy paints for this purpose are available from Spectrum Coatings of Providence, R.I.

In another version of the invention, a cracked ornament is produced from a shaped glass crystal, such as those offered by Ar. Ran of Istanbul, Turkey. The crystal is (1) heated for approximately 8 minutes at 400 degrees Fahrenheit. It is then (2) promptly dipped into a bath of ambient temperature water for a few seconds. Upon removal, the crystal is (3) hung up to dry and cool. After about 15 minutes, (4) an acrylic resin is applied, for example by spraying, to the cracked crystal to help in holding it together. Acrylic resins appropriate for this purpose include UV resins sold by Loctite Americas of Rocky Hill, Conn. 06067.

In a variation of this latter approach, an additional step may be added between steps 3 and 4. After the cracked glass crystal has dried and cooled, epoxy paint of any desired color may be applied to the crystal—for example, along the edge of one side of the crystal—to provide additional visual effects. The crystal should be baked for approximately 30 minutes at about 300 degrees Fahrenheit to set the epoxy. Suitable epoxy paints for this purpose are available from Spectrum Coatings of Providence, R.I.

Several embodiments of the invention have been described herein. However, it will be recognized that variations from those embodiment may be made without straying from the invention.

1. A method for manufacturing decorative glass ornaments comprising:
heating glass material to substantially its melting temperature;
molding the material into a desired shape;
immersing the molded material for a brief time, and prior to significant cooling, in a liquid medium having a temperature substantially below the melting temperature of the glass material, thereby producing cracks or veining in the molded glass material.

2. The method of claim 1, further comprising adding image-altering agents to the heated glass material prior to molding.

3. The method of claim 1, further comprising, after immersing the molded material in the liquid medium, placing the molded material in sand heated to a temperature greater than the temperature of the liquid medium.

4. The method of claim 1, further comprising pre-heating the molds wherein the molding of the heated glass material is effected, to a temperature similar to the melting temperature of the heated glass material.

5. The method of claim 1, further comprising applying paint to the molded glass material after it has dried and cooled, to produce additional visual effects.

6. A method for producing decorative glass ornaments from a substantially pre-shaped glass crystal, comprising:
heating the shaped crystal to a temperature of about 400 degrees Farenheit;
immersing the heated crystal for a brief time in an ambient temperature liquid medium, thereby producing cracks or veining in the crystal;
allowing the crystal to dry and cool; and
applying an acrylic resin to the crystal to increase its integrity.

7. The method of claim 6 further comprising applying paint to the molded glass material after it has dried and cooled, to produce additional visual effects.

8. A decorative glass ornament having cracks or veining similar to that of naturally-occurring quartz, produced by heating glass material to substantially its melting temperature; molding the material into a desired shape; and immersing the molded material for a brief time, and prior to significant cooling, into a liquid medium having a temperature substantially below the melting temperature of the glass material, thereby producing cracks in the molded glass material.

9. A decorative glass ornament having cracks or veining similar to that of naturally-occurring quartz, produced by heating a substantially pre-shaped glass crystal to a temperature of about 400 degrees Farenheit; immersing the heated crystal for a brief time into an ambient temperature liquid medium to thereby produce cracks in the crystal; allowing the crystal to dry and cool; and applying an acrylic resin to the crystal to increase its integrity.
